(19) United States
(12) Patent Application Publication
(10) Pub. No.: US 2018/0319684 A1
(43) Pub. Date: Nov. 8, 2018

(54) REMOVAL OF CONTAMINATES BY COPPER (I) CATALYSTS

(71) Applicant: PHILLIPS 66 COMPANY, Houston, TX (US)

(72) Inventors: James Bryant Pollock, Collinsville, OK (US); Robert Greenway, Skiatook, OK (US); Seetha Soundara Manickam, Wheeling, IL (US); Richard H. Brezinsky, Owasso, OK (US)

(73) Assignee: PHILLIPS 66 COMPANY, Houston, TX (US)

(21) Appl. No.: 15/956,466

(22) Filed: Apr. 18, 2018

Related U.S. Application Data
(60) Provisional application No. 62/500,736, filed on May 3, 2017.

(51) Int. Cl. C02F 1/72

(52) U.S. Cl. CPC C02F 1/725; C02F 2103/365

(57) ABSTRACT

A process for producing a treated wastewater stream from an initial gaseous wastewater stream. The process begins by condensing a gaseous wastewater stream into a liquid wastewater stream wherein the liquid wastewater stream contains at least one compound susceptible to treatment by chemical oxidation. Both a chemical oxidizer and a copper (I) catalyst are then fed into the liquid wastewater stream. The copper (I) catalyst with the at least one compound are then precipitated to produce a treated wastewater stream.

### CROSS-REFERENCE TO RELATED APPLICATIONS

This application is a non-provisional application which claims the benefit of and priority to U.S. Provisional Application Ser. No. 62/500,736 filed May 3, 2017, entitled “Removal of Contaminates by Copper (I) Catalysts,” which is hereby incorporated by reference in its entirety.

### STATEMENT REGARDING FEDERALLY SPONSORED RESEARCH OR DEVELOPMENT

None.

### FIELD OF THE INVENTION

This invention relates to the removal of contaminates by copper (I) catalysts.

### BACKGROUND OF THE INVENTION

Wastewater streams are typically produced at various points within a refinery some of which include desalters, sour water strippers, and caustic wash systems. However, each of these methods has its limitations.

For example, a sour water stripper removes carbon dioxide, hydrogen sulfide and ammonia from the sour water generated in the refinery. The sour water is received from the refinery in the flash drum, where light hydrocarbons are flashed off. The sour water is then fed to the feed prep tank, where the feed is mixed and stabilized. Liquid hydrocarbons entrained in the sour water are removed in the feed prep tank. The sour water is then heated in the feed/bottoms exchanger and fed to the stripper column. Steam, generated in the reboiler, heats the water and strips the hydrogen sulfide and ammonia from the water to produce a stripped wastewater stream. This stripped wastewater stream is often unsuitable for direct reuse because of various factors and incompatibly high levels of total organic carbon (TOC).

Other methods have been proposed to dispose of wastewater streams. For example, in conventional incineration processes, combustion of a fuel oil and natural gas sustains the evaporation of the aqueous parts of the waste liquor, yielding carbon dioxide and alkali metal carbonates. One major drawback with conventional incineration is that fuel oil and natural gas are relatively expensive fuel sources, especially in view of the substantial quantities of spent caustic generated during petroleum refining and petrochemical processing requiring treatment.

U.S. Pat. No. 6,576,144 attempts solve the problem of wastewater streams but their reaction mechanism is limited to copper (II) catalysts due to the addition of process water in the reaction. This reaction requires significant pH adjustment that is costly and inefficient.

There remains a need for a more efficient and cost effective method of treating stripped wastewater streams.

### BRIEF SUMMARY OF THE DISCLOSURE

A process for producing a treated wastewater stream from an initial gaseous wastewater stream. The process begins by condensing a gaseous wastewater stream into a liquid wastewater stream wherein the liquid wastewater stream contains at least one compound susceptible to treatment by chemical oxidation. Both a chemical oxidizer and a copper (I) catalyst are then fed into the liquid wastewater stream. The copper (I) catalyst with the at least one compound are then precipitated to produce a treated wastewater stream.

In an alternate embodiment, a process is also taught for producing a treated wastewater stream from an initial gaseous wastewater stream. The process begins by condensing a gaseous wastewater stream into a liquid wastewater stream wherein the liquid wastewater stream contains at least one compound susceptible to treatment by chemical oxidation. Both a chemical oxidizer and a copper (I) catalyst are then fed into the liquid wastewater stream. The copper (I) catalyst with the at least one compound are then precipitated to produce a treated wastewater stream. In this process the process occurs within a closed system and no additional reactants are added to the process.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts the X-Ray Powder Diffraction of the precipitated material after treating the wastewater stream.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

A process for producing a treated wastewater stream from an initial gaseous wastewater stream. The process begins by condensing a gaseous wastewater stream into a liquid wastewater stream wherein the liquid wastewater stream contains at least one compound susceptible to treatment by chemical oxidation. Both a chemical oxidizer and a copper (I) catalyst are then fed into the liquid wastewater stream. The copper (I) catalyst with the at least one compound are then precipitated to produce a treated wastewater stream.

In the current process, the first step involves a gaseous wastewater stream is condensed into a liquid wastewater stream wherein the liquid wastewater stream contains at least one compound susceptible to treatment by chemical oxidation. In some embodiments, this first step or the entire process occurs in a closed system to ensure zero to minimal amounts oxygen enters the process. Minimal amounts of oxygen can non-limiting to be defined as minimal amounts to disrupt the reactions that occur in the current process. In one embodiment, minimal amounts of oxygen can be defined as less the 0.5 ppm of oxygen.

In some embodiments, this process can occur in a refinery. When occurring in a refinery, the process of condensing gaseous wastewater stream is condensed into a liquid wastewater stream can occur from closed systems such as a desalter, a sour water stripper, or a spent caustic tank.

For example, if this process occurred from a sour water stripper, a gaseous wastewater stream would be condensed into a liquid wastewater stream within a sour water stripper. The sour water stripper used in this embodiment can be any conventionally used sour water stripper column where a dehydrosulfurization process is used to remove H₂S and/or NH₃ from sour water. Typically, undergoing a dehydrosulfurization process will cause the sour water to become stripped sour water which is largely void of oxygen. In one embodiment, the stripped sour water can have less than 0.5 ppm of oxygen.

In one embodiment, the process is consisting essentially of condensing a gaseous wastewater stream into a liquid wastewater stream wherein the liquid wastewater stream contains at least one compound susceptible to treatment by chemical oxidation. A chemical oxidizer and a copper (I) catalyst are then fed into the liquid wastewater stream. The copper (I) catalyst with the at least one compound are then precipitated to produce a treated wastewater stream. The use of consisting essentially of is used to limit the scope of the materials or steps of this embodiment of the process to those that do not materially affect the basic and novel characteristics of the process.

The temperature of the liquid wastewater stream is typically less than 150° C., 120° C. or even 100° C. In one embodiment, the temperature of the wastewater stream can range from about 20° C. to about 150° C.

The pH of the liquid wastewater stream typically ranges from about 2 to about 7 or even from about 5 to about 7. In one embodiment, the pH of the liquid wastewater stream is adjusted to reach this range. In another embodiment, the pH of the liquid wastewater stream does not need adjusting to reach this range. It is envisioned that the pH of the treated wastewater stream would be higher than the pH of the liquid wastewater stream. In one embodiment, the pH of the treated wastewater stream ranges from about 7 to about 9.

The pressure of the stripped wastewater stream typically is typically less than 1.5 atm, at 1 atm, or even less than 1 atm.

In one embodiment, the at least one compound susceptible to treatment by chemical oxidation is organic carbon, sulfidic compounds, phenolic compounds, cresylic compounds, naphthenic compounds, free oils, emulsified oils, suspended oils, amines and combinations thereof.

In another embodiment, the chemical oxidizer is selected from the group of hydrogen peroxide, potassium permanganate, ozone, oxygen, chlorine dioxide, peroxymonosulfuric acid, chlorine, sodium hypochlorite, persulfate and combinations thereof.

The amount of chemical oxidizer added can be from about 0.1 wt % to about 10 wt % in relation to the total volume of the liquid wastewater stream. In another embodiment, the amount of chemical oxidizer added can be from about 0.1 wt % to about 5 wt % in relation to the total volume of the liquid wastewater stream.

In one embodiment, the copper (I) catalyst is a copper (I) salt. In another embodiment, the copper (I) salt is copper (I) chloride, copper (I) bromide, copper (I) iodide and combinations thereof.

In yet another embodiment, the precipitate of the copper (I) catalyst and the at least one compound are filtered from the treated wastewater stream using any conventionally known filtering method such as clarification, multi-media filtration, or membrane filtration.

In one embodiment, the chemical oxidizer can be added stepwise in at least two consecutive additions. In this embodiment, the copper (I) catalyst would be fed into the liquid wastewater stream in addition with a certain amount of chemical oxidizer. After a set period of time for the reaction to occur another dose of chemical oxidizer can be added to the reaction process. In this embodiment, sufficient doses of the chemical oxidizer can be added until the process is completed. This could be 2, 3, 4, 5, 10, even 12 stepwise additions.

The amount of copper (I) catalyst added can be from about 25 ppm to about 300 ppm in relation to the total volume of the liquid wastewater stream. In another embodiment, the amount of copper (I) catalyst added can be from about 50 ppm to about 200 ppm in relation to the total volume of the liquid wastewater stream.

The following examples of certain embodiments of the invention are given. Each example is provided by way of explanation of the invention, one of many embodiments of the invention, and the following examples should not be read to limit, or define, the scope of the invention.

### Example 1

A sample of a liquid wastewater stream was treated with 100 ppm CuCl and 50,000 ppm of hydrogen peroxide was run for 1 hour at 80° C. to produce a treated wastewater stream.

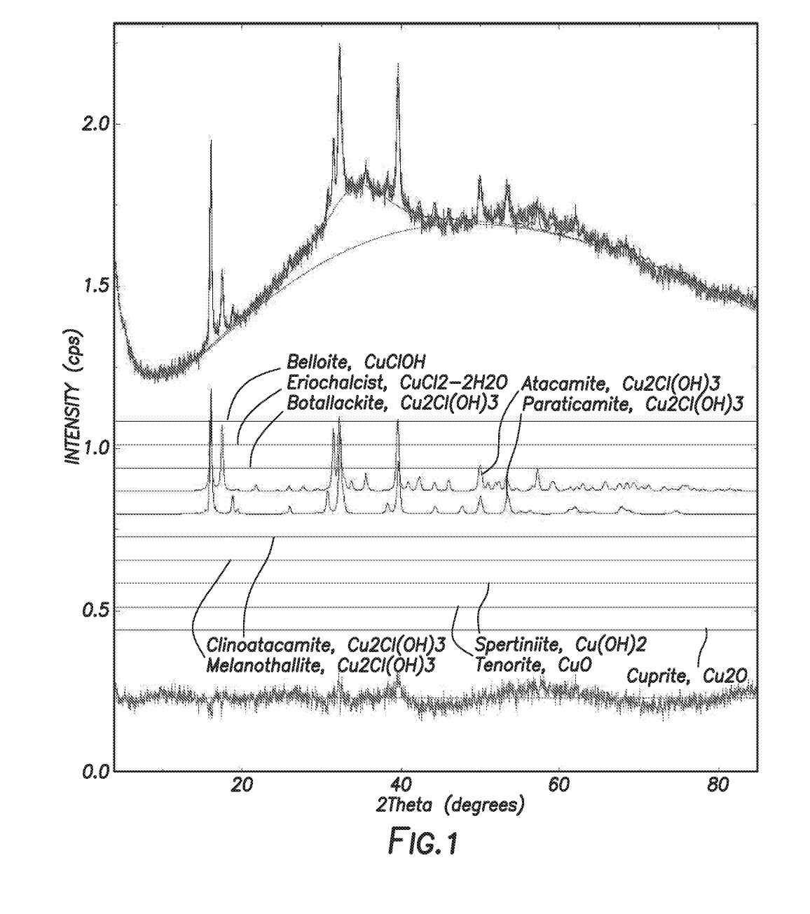

FIG. 1, depicts the x-ray powder diffraction of the precipitate formed after treating the wastewater stream. Results of the x-ray powder diffraction determined that the copper precipitate within the treated wastewater stream existed in two forms: 56.1 wt % of atacamite Cu₂Cl(OH)₃ and 43.9 wt % of paratacamite Cu₂Cl(OH)₃.

TABLE 1
Table 1 = pH and total organic carbon numbers (TOC)
of liquid wastewater stream and treated wastewater stream.

| Treatment | pH | TOC |
|---|---|---|
| Liquid wastewater stream | 6.32 | 277 |
| Treated wastewater stream | 8.25 | 45.4 |

TABLE 2
Table 2 = inductively coupled plasma mass spectrometry
of liquid wastewater stream and treated wastewater stream.

| | | |
|---|---|---|
| Element | Liquid wastewater stream | Treated wastewater stream |

| | | | | |
|---|---|---|---|---|
| Se | 727 | parts per billion | 771 | parts per billion |
| Fe | 0.129 | parts per million | <0.05 | parts per million |
| Cu | 0.012 | parts per million | 3.09 | parts per million |
| Zn | 0.122 | parts per million | <0.05 | parts per million |

TABLE 3
Table 3 = gas chromatography of liquid
wastewater stream and treated wastewater stream.

| | Liquid wastewater | Treated wastewater |
|---|---|---|
| | stream (Parts per | stream (Parts per |
| Compound | million) | million) |
| o-cresol | 6.1 | 0 |
| phenol | 17.3 | 0 |
| 2,5-dimethylphenol | 0.6 | 0 |
| 2,4-dimethylphenol | 1.3 | 0 |
| p-cresol | 6.2 | 0 |
| m-cresol | 6.0 | 0 |
| total phenols | 37.5 | 0 |
| 2-butanone | 17.0 | 25.2 |
| propanoic acid | 19.9 | 0 |
| benzothiazole | 9.4 | 15.1 |
| total compounds | 83.8 | 40.3 |

TABLE 4
Table 4 = ion chromatography of liquid
wastewater stream and treated wastewater stream.

| | Liquid wastewater | Treated wastewater |
|---|---|---|
| Sample | stream (ug/ml) | stream (ug/ml) |
| chloride | 19 | 25 |
| phosphate | 1 | <1 |
| sulfate | 2 | 41 |
| oxalate | <1 | 6 |
| thiosulfate | 2 | <1 |
| thiocyanate | 4 | <1 |
| sodium | 5 | 3 |
| ammonium | 61 | 75 |
| potassium | 19 | <1 |
| monoethanolamine | 4 | <1 |
| methylamine | 5 | 4 |
| diethanolamine | 28 | <1 |
| N-methyldiethanolamine | 5 | <1 |
| morpholine | 5 | <1 |
| acetate | 97 | 72 |
| propionate | 46 | <1 |
| butyrate | 21 | <1 |
| valerate | 9 | <1 |
| caproate | 4 | <1 |

TABLE 5
Table 5 = inductively coupled plasma mass spectrometry
of liquid wastewater stream and treated wastewater stream.

| Sample | Liquid wastewater stream | | Treated wastewater stream | |
|---|---|---|---|---|
| Selenite | 1.1% | Area | 2.5% | Area |
| Selenate | 0% | Area | 97.5% | Area |
| Selenocyanate | 98.9% | Area | 0% | Area |

### Example 2

Two samples of an acetate stream to simulate total organic carbons were treated with 100 ppm CuCl and 10,000 ppm of hydrogen peroxide at 90° C. to produce a simulated treated wastewater stream. In the first sample, the addition of hydrogen peroxide was added as a batch addition. In the second sample, the addition of hydrogen peroxide was added stepwise in 5 different additions. The % total organic carbon removal in the first sample was 59%. The % total organic carbon removal in the second sample was 97%.

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A process comprising:
condensing a gaseous wastewater stream into a liquid wastewater stream wherein the liquid wastewater stream contains at least one compound susceptible to treatment by chemical oxidation;
feeding both a chemical oxidizer and a copper (I) catalyst into the liquid wastewater stream; and
precipitating the copper (I) catalyst with the at least one compound to produce a treated wastewater stream wherein the process occurs within a closed system.

2. The process of claim 1, wherein the temperature of the liquid wastewater stream is less than 150° C.

3. The process of claim 1, wherein the pressure of the liquid wastewater stream is less than 1.5 atm.

4. The process of claim 1, wherein the pH of the liquid wastewater stream ranges from about 2 to about 7.

5. The process of claim 1, wherein the pH of the treated wastewater stream ranges from about 7 to about 9.

6. The process of claim 1, wherein the pH of the treated wastewater stream is higher than the pH of the liquid wastewater stream.

7. The process of claim 1, wherein the at least one compound is selected from the group consisting of: organic carbon, organic carbon, sulfidic compounds, phenolic compounds, cresylic compounds, naphthenic compounds, free oils, emulsified oils, suspended oils, amines and combinations thereof.

8. The process of claim 1, wherein the copper (I) catalyst is a copper (I) salt.

9. The process of claim 8, wherein the copper (I) salt is selected from the group consisting of: copper (I) chloride, copper (I) bromide, copper (I) iodide and combinations thereof.

10. The process of claim 1, wherein the chemical oxidizer is selected from the group consisting of: hydrogen peroxide, potassium permanganate, ozone, oxygen, chlorine dioxide, peroxymonosulfuric acid, chlorine, sodium hypochlorite, persulfate, and combinations thereof.

11. The process of claim 1, wherein the precipitate of the copper (I) catalyst and the at least one compound are filtered from the treated wastewater stream.

12. The process of claim 1, wherein the amount of copper (I) catalyst is added from about 50 ppm to about 200 ppm in relation to the total volume of the liquid wastewater stream.

13. The process of claim 1, wherein the amount of chemical oxidizer is added from about 0.1 wt % to about 5 wt % in relation to the total volume of the liquid wastewater stream.

14. The process of claim 1, wherein the chemical oxidizer is added stepwise in at least two consecutive additions.

15. The process of claim 1, wherein the process occurs within a closed system.

16. The process of claim 15, wherein the closed system is selected from the group consisting of: a desalter, a sour water stripper, a spent caustic tank, or combinations thereof.

17. A process consisting essentially of:
condensing a gaseous wastewater stream into a liquid wastewater stream wherein the liquid wastewater stream contains at least one compound susceptible to treatment by chemical oxidation;
feeding both a chemical oxidizer and a copper (I) catalyst into the liquid wastewater stream; and
precipitating the copper (I) catalyst with the at least one compound to produce a treated wastewater stream wherein the process occurs within a closed system.
